(19) United States
(12) Patent Application Publication
(10) Pub. No.: US 2026/0336702 A1
(43) Pub. Date: Oct. 29, 2026

(54) SUSPENSION MEMBER

(71) Applicants: Kureha TAKASAKI, Nagoya-shi (JP); Takayuki KIRIMOTO, Nisshin-shi (JP); Keisuke SHIMIZU, Ogaki-shi (JP)

(72) Inventors: Kureha TAKASAKI, Nagoya-shi (JP); Takayuki KIRIMOTO, Nisshin-shi (JP); Keisuke SHIMIZU, Ogaki-shi (JP)

(73) Assignees: TOYOTA JIDOSHA KABUSHIKI KAISHA, Aichi-ken (JP); PACIFIC INDUSTRIAL CO., LTD., Gifu (JP)

(21) Appl. No.: 19/643,808

(22) Filed: Apr. 10, 2026

(30) Foreign Application Priority Data
Apr. 23, 2025 (JP) 2025-071270

(51) Int. Cl. B62D 21/02

(52) U.S. Cl. CPC B62D 21/02

(57) ABSTRACT

A suspension member has a pair of side rails that extend in a front-and-rear direction, a pair of cross members that connect the pair of side rails, and a rail reinforcement attached to the side rail and having an upper wall and a side wall. The rail reinforcement has a step portion in which a height of an upper surface of the upper wall changes by a certain degree or greater in the front-and-rear direction, and a notch formed on the side wall, and formed at a position in the front-and-rear direction approximately coincident with the step portion.

### CROSS REFERENCE TO RELATED APPLICATION

This application claims priority to Japanese Patent Application No. 2025-071270 filed on Apr. 23, 2025, which is incorporated herein by reference in its entirety including the specification, claims, drawings, and abstract.

### TECHNICAL FIELD

The present disclosure relates to a suspension member, a part of which is reinforced by a reinforcement.

### BACKGROUND

Generally, a skeletal member called a suspension member is disposed in a vehicle. For example, a suspension member comprises a pair of side rails which extend in a vehicle front-and-rear direction, a front cross member which connects front ends of the pair of side rails, and a rear cross member which connects rear ends of the pair of side rails. Such a suspension member supports a suspension. In the event of a vehicle collision, the suspension member is expected to plastically deform, and thereby absorb collision energy.

For example, JP 2018-114814 A discloses a suspension member in which separate members are employed for the rear cross member and the side rails so that the collision energy can be efficiently absorbed. In such a structure, when a power unit moves rearward and collides with the rear cross member during a collision, the rear cross member is separated from the side rails before the side rail ruptures. With this configuration, rupturing of the side rail can be effectively prevented, and the collision load can be efficiently absorbed by the side rail.

However, in the related art such as that described in JP 2018-114814 A, controlling the bending position of the side rail has been problematic. When the collision load is applied to the side rail, bending occurs in the side rail. In the related art, the position of the bending varies, and the positional relationship between the side rail and the other members after the occurrence of the bending also varies.

An advantage of the present disclosure lies in provision of a suspension member in which a bending position of the side rail during collision can be controlled.

### SUMMARY

According to one aspect of the present disclosure, there is provided a suspension member including a pair of side rails that extend in a front-and-rear direction; a pair of cross members that connect the pair of side rails; and a rail reinforcement that is attached to the side rail and that has an upper wall and a side wall, wherein the rail reinforcement includes: a step portion in which a height of an upper surface of the upper wall changes by a certain degree or greater in the front-and-rear direction; and a notch formed on the side wall, and formed at a position in the front-and-rear direction approximately coinciding with the step portion.

In this configuration, the step portion may be a groove-shaped portion depressed in comparison with regions in front of and in rear of the step portion.

The upper wall may have a base surface and a bead bulging upward relative to the base surface, and a width of the bead at the step portion may be smaller than widths of the bead at regions in front of and in rear of the step portion.

The upper wall may have a base surface and a bead bulging upward relative to the base surface, and the notch may reach from a lower end of the side wall to the base surface.

Further, the side rail may be formed by joining an upper panel, and a lower panel disposed at a lower side of the upper panel, the upper panel may include a front upper panel, and a rear upper panel which extends from a region near a rear end of the front upper panel toward a rear side of a vehicle, the rail reinforcement may be disposed at a lower side of the front upper panel, a rear end portion of the front upper panel, a rear end portion of the rail reinforcement, and a front end portion of the rear upper panel may overlap each other in an up-and-down direction, and the base surface may have a lowest height, and a gap may be present between the base surface and the front upper panel, at a position in the front-and-rear direction coincident with the step portion.

According to an aspect of the present disclosure, stress is concentrated at the step portion, and the bending tends to more easily occur at the step portion. In other words, the bending position of the side rail can be controlled by adjusting the position of the step portion.

### BRIEF DESCRIPTION OF DRAWINGS

Embodiments of the present disclosure will be described based on the following figures, wherein:

FIG. 1 is a perspective diagram of a suspension member;

FIG. 2 is an exploded perspective diagram of a side rail at a periphery of a rail reinforcement;

FIG. 3 is a plan view and a cross-sectional view along a line A-A of the rail reinforcement; and

FIG. 4 is a schematic diagram showing a difference in a shape of a side rail due to a difference in a bending position of the side rail.

### DESCRIPTION OF EMBODIMENTS

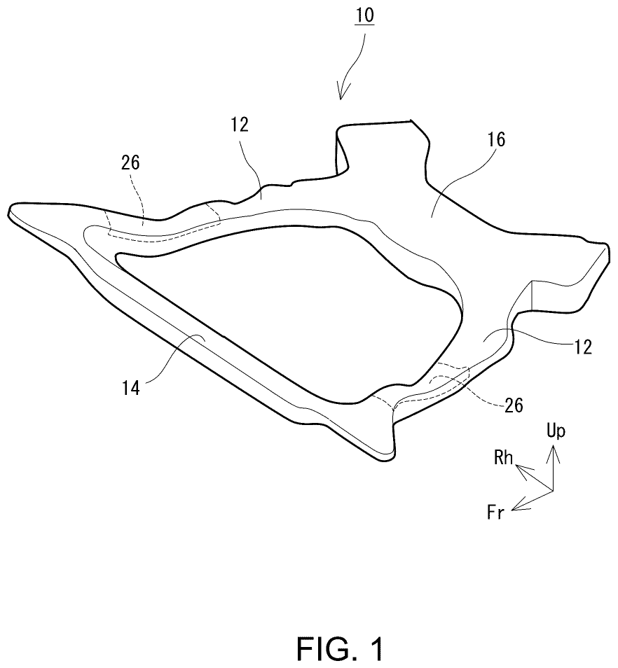

A structure of a suspension member 10 will now be described with reference to the drawings. FIG. 1 is a perspective diagram of the suspension member 10. In the drawings, “Up”, “Fr”, and “Rh” respectively indicate an upper side, a front side, and a right side of a vehicle.

The suspension member 10 is, for example, a front suspension member disposed at a front part of a passenger car. The suspension member 10 is a skeletal member comprising a pair of side rails 12, a front cross member 14, and a rear cross member 16. The side rail 12 extends generally in a vehicle front-and-rear direction, more specifically, in a direction slightly inclined with respect to the front-and-rear direction. The front cross member 14 connects front ends of the pair of side rails, and extends in a vehicle width direction. The rear cross member 16 connects rear ends of the pair of side rails, and extends in the vehicle width direction. The suspension member 10 as a whole has an approximately trapezoidal shape having a smaller width at a rear end of the vehicle than at a front end of the vehicle.

Four corners of the suspension member 10 are fixed on a body of the vehicle. In addition, lower arms (not shown) of left and right suspension apparatuses are respectively attached to the left and right side rails 12. Further, a power unit (not shown) including a motive power source (for example, an engine or a motor) is disposed above the suspension member 10. The power unit is supported by the suspension member 10 from below, via a mounting member.

The front cross member 14 has a quadrangular closed cross-sectional shape in a cross-sectional view orthogonal to a longitudinal direction thereof (vehicle width direction). The front cross member 14 may be formed, for example, through extrusion molding of a light metal material such as an aluminum alloy, or by joining a plurality of panels. The rear cross member 16 has an open cross-sectional shape with a lower side of the vehicle body opened, and has an approximately quadrangular shape in the plan view. The rear cross member 16 may be formed, for example, through die casting a light metal material such as an aluminum alloy.

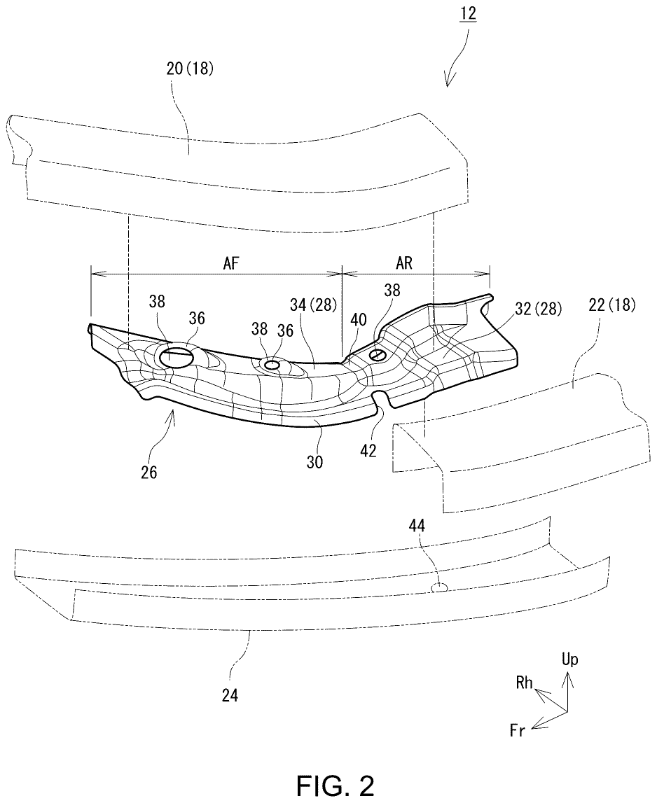

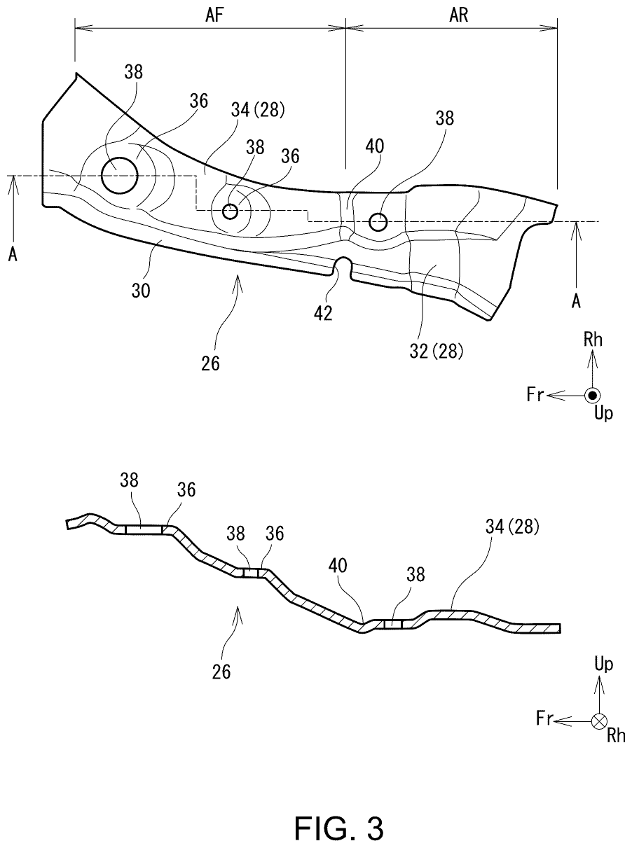

The side rail 12 is formed by joining a plurality of panel members in the vehicle front-and-rear direction, and has a quadrangular closed cross-sectional shape in the cross-sectional view along a longitudinal direction thereof (vehicle front-and-rear direction). The side rail 12 will now be described with reference to FIGS. 2 and 3. FIG. 2 is an exploded perspective diagram of the side rail 12 at a periphery of a rail reinforcement 26 (hereinafter, also referred to as “rail R/F 26”) to be described later. FIG. 3 is a plan view and a cross-sectional view along a line A-A of the rail R/F 26.

As shown in FIG. 2, the side rail 12 comprises an upper panel 18, a lower panel 24, and the rail R/F 26. FIG. 2 shows the upper panel 18 and the lower panel 24 with the respective shapes simplified. The rail R/F 26 is disposed at a location indicated by a dotted line in FIG. 1, that is, a region near the front end of the side rail 12.

As shown in FIG. 2, the upper panel 18 can be largely divided into a front upper panel 20 and a rear upper panel 22. In the following, the “front” and the “rear” are also represented with “Fr” and “Rr”, respectively. The Fr upper panel 20 is a panel member having an approximate U-shaped cross section with a lower side of the vehicle opened. The Rr upper panel 22 is a panel member which extends from a region near a rear end of the Fr upper panel 20 toward a rear side of the vehicle. Similar to the Fr upper panel 20, the Rr upper panel 22 has an approximate U-shaped cross section opening to a lower side of the vehicle.

The Fr upper panel 20 and the Rr upper panel 22 are welded together, to form the upper panel 18. Although not shown in FIG. 2, a plurality of fastening holes for fastening other members (for example, a mounting member or the like) are formed on an upper surface of the upper panel 18. In addition, while FIG. 2 shows the upper surface of the upper panel 18 as a smooth surface without protrusions and recesses, in reality, a plurality of protrusions and recesses are formed on the upper surface of the upper panel 18, for securing strength and a fastening seat surface.

The lower panel 24 is a panel member disposed at a lower side of the upper panel 18. The lower panel 24 has an approximate U-shaped cross section opening to an upper side of the vehicle. The lower panel 24 is welded to the upper panel 18 in a state facing the upper panel 18. In this manner, the side rail 12 having an approximately quadrangular cross section is formed. On a bottom surface of the lower panel 24 is formed a drainage hole 44 for draining moisture from an inside of the side rail 12 to the outside. While FIG. 2 shows the lower panel 24 as one component, the lower panel 24 may alternatively be formed by joining a plurality of panel members, similar to the upper panel 18.

At the front part of the side rail 12, the rail R/F 26 is disposed. The rail R/F 26 is a panel member welded to the upper panel 18, for reinforcing the upper panel 18. In the present embodiment, the rail R/F 26 is disposed at a lower side of the Fr upper panel 20, and is welded to the Fr upper panel 20.

More specifically, the rail R/F 26 is a panel member having an upper wall 28 and a pair of side walls 30, and has an approximate U-shaped cross section with a lower side of the vehicle opened. The side wall and a front end portion of the rail R/F 26 are welded to the Fr upper panel 20. In addition, a rear end portion of the Fr upper panel 20, a rear end portion of the rail R/F 26, and a front end portion of the Rr upper panel 22 are welded to each other in this order in a state of being overlapped in the up-and-down direction. In other words, the rear end portion of the rail R/F 26 is sandwiched in the up-and-down direction by the rear end portion of the Fr upper panel 20 and the front end portion of the Rr upper panel 22. In order to enable such a configuration, the rear end of the rail R/F 26 is positioned at a rear side relative to the rear end of the Fr upper panel 20, and at a front side relative to the front end of the Rr upper panel 22.

The upper wall 28 of the rail R/F 26 further comprises a base surface 32, and a bead 34 which bulges from the base surface 32. The bead 34 is a protrusion of a line shape elongated in the vehicle front-and-rear direction. With the provision of the bead 34, rigidity of the rail R/F 26, and, consequently, of the side rail 12, can be improved.

On an upper surface of the bead 34 (that is, an upper surface of the upper wall 28), a step portion 40 to be described below is formed. In the following, a region at the front side of the step portion 40 will be referred to as a “front-side region AF”, and a region at the rear side of the step portion 40 will be referred to as a “rear-side region AR”. The step portion 40 is positioned slightly at the rear side of a center in the front-and-rear direction of the bead 34. Because of this, the front-side region AF is slightly longer than the rear-side region AR.

As shown at a lower part of FIG. 3, in the front-side region AF, the upper surface of the bead 34 is inclined gradually toward the lower side from the front end toward the rear side. On the other hand, in the rear-side region AR, the upper surface of the bead 34 extends substantially in the horizontal direction, although there is slight unevenness. Two fastening holes 38 are formed in the front-side region AF, and one fastening hole 38 is formed in the rear-side region AR. A portion of the of the bead 34 bulges upwardly to form approximately horizontal fastening seat surfaces 36 at the peripheries of the fastening holes 38.

Here, the step portion 40 exists at a boundary between the front-side region AF and the rear-side region AR, and, in the step portion 40, a height of the upper surface of the bead 34 varies by a certain degree or greater in the front-and-rear direction. As is clear from FIG. 2 and the lower part of FIG. 3, the step portion 40 is a groove-shaped portion depressed in comparison with regions in front of and in rear of the step portion 40. The reason for providing such a step portion 40 on the upper surface of the bead 34 will be described later.

As is clear from FIG. 2 and an upper part of FIG. 3, a width of the bead 34 varies depending on the position. For example, at a region near the front end of the rail R/F 26, the width of the bead 34 is approximately equal to a width of the upper wall 28. As a result, at the region near the front end of the rail R/F 26, there is almost no base surface 32. The width of the bead 34 is gradually reduced from the front end toward the step portion 40. The width of the bead 34 then increases immediately after passing the step portion 40. In other words, the width of the bead 34 at the step portion 40 is smaller than the widths of the bead 34 at the regions in front of and in rear of the step portion 40.

A notch 42 is formed on the side wall 30. The notch 42 extends from a lower end of the side wall 30 to the base surface 32. A position in the front-and-rear direction of the notch 42 approximately coincides with the position in the front-and-rear direction of the step portion 40. In other words, the notch 42 is adjacent to the step portion 40 in the vehicle width direction.

With the rail R/F 26 having the structure as described above, deformation of the side rail 12 during a collision can be controlled more reliably, as will now be described. For example, a front collision may be considered, in which an obstacle collides at the front side of the vehicle. In this case, a collision load directed toward the rear side of the vehicle is applied to the suspension member 10, and, consequently, to the side rail 12. The collision energy is absorbed by deformation of the side rail 12 upon receiving the collision load, protecting important portions, such as a vehicle cabin.

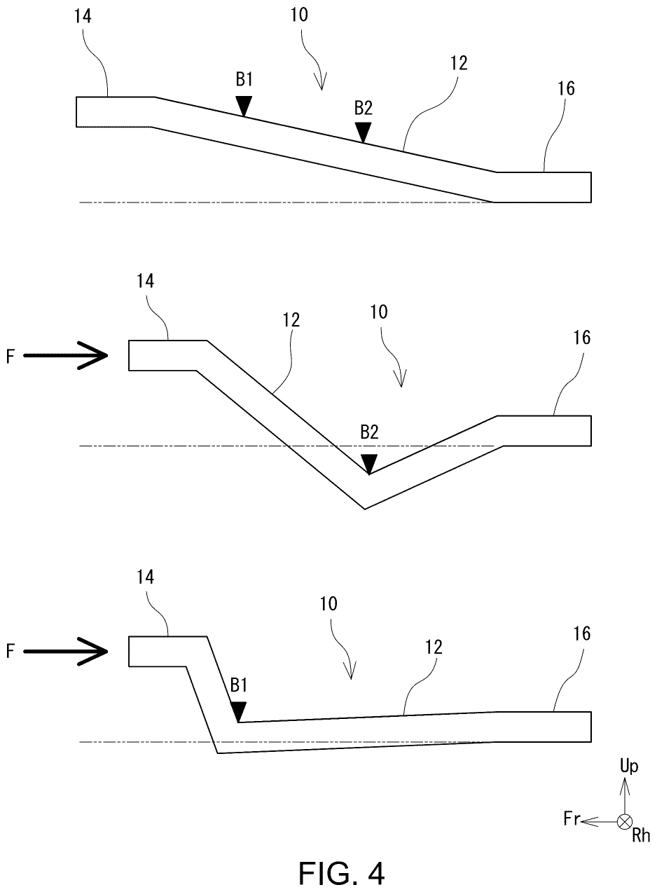

However, when the deformation of the side rail caused upon receiving the collision load significantly varies, the behavior of peripheral members during the collision also vary, and there may be cases in which energy absorption cannot be achieved as presumed. For example, if the bending position of the side rail 12 upon receiving the collision differs, a lap amount in a height direction of the side rail 12 and the peripheral components (such as, for example, the power unit), and an inclination angle of the side rail 12 will vary. FIG. 4 is a schematic diagram showing a difference in a shape of the side rail 12 due to a difference in the bending position of the side rail 12. An upper part of FIG. 4 is a schematic diagram of the suspension member 10 before collision, and a middle part and a lower part of FIG. 4 are schematic diagrams of the suspension member 10 after the collision. As shown in the middle and lower parts of FIG. 4, when the collision load F is received, the shape of the side rail 12 significantly changes when the bending positions B1 and B2 of the side rail 12 differ, even when the rearward movement distance of the front cross member 14 is the same. As a result of this difference, an interference situation of the side rail 12 and the peripheral components also significantly changes. Consequently, there is a possibility that the collision energy cannot be absorbed as presumed.

In consideration of this, in the present embodiment, the step portion 40 is provided on the rail R/F 26. With the provision of the step portion 40, as described, the step portion 40 is a groove-shaped portion depressed in comparison with the regions in front of and in rear of the step portion 40. This groove-shaped portion extends in the vehicle width direction. In addition, the width of the bead 34 is temporarily narrowed at the step portion 40. That is, the width of the bead 34 at the step portion 40 is smaller than the widths of the bead 34 at the regions in front of and in rear of the step portion 40. As a result, a cross-section coefficient at the placement position of the step portion 40 is smaller than a cross-section coefficient at the other portions, so that stress tends to concentrate at the step portion 40. In addition, in the present embodiment, the notch 42 is formed at approximately the same position in the front-and-rear direction as the step portion 40. With this configuration, the cross-section coefficient near the step portion 40 is further reduced.

With the above configuration, when the collision load is received, the stress concentrates at the step portion 40, and the bending tends to occur more easily at the step portion 40. As a result, variation in the bending position, and, consequently, variation in the relative positional relationship between the suspension member 10 and the peripheral components, can be suppressed. Further, with this configuration, the collision energy can be absorbed in a manner close to the presumption during the design of the vehicle, and the important components can be appropriately protected.

With the provision of the notch 42 on the side wall 30 of the rail R/F 26, it becomes possible to reliably drain moisture from the inside of the side rail 12. That is, there may be cases where water accumulates inside the side rail 12. For example, water may intrude from a gap between the panel members into the side rail 12. Alternatively, water formed through condensation may collect inside the side rail 12. If the rail R/F 26 is in contact with water for a long period of time, the water may cause corrosion. The water entering the gap between the Fr upper panel 20 and the rail R/F 26 tends to accumulate at the most depressed location, that is, the periphery of the step portion 40. In the present embodiment, the notch 42 is disposed adjacent to the step portion 40. As a result, the water entering the gap between the Fr upper panel 20 and the rail R/F 26 easily flows into the notch 42, and drains downward. The drainage hole 44 is formed on the lower panel 24 disposed at the lower side of the rail R/F 26. The water draining from the notch 42 drains to the outside through the drainage hole 44. Thus, according to the present embodiment, the water in the side rail 12 can be appropriately drained away.

The structures described above are merely exemplary, and may be suitably changed so long as the structures of Claim 1 of the present disclosure are provided. For example, in the above description, the width of the bead 34 is locally narrowed at the step portion 40. Alternatively, the width of the bead 34 at the step portion 40 may be identical to the widths of the bead 34 at the regions in front of and in rear of the step portion 40. Further, the notch 42 may have a structure which does not reach the base surface 32, and which remains within the side wall 30. Moreover, in the above description, the upper panel 18 is divided into the Fr upper panel 20 and the Rr upper panel 22, the upper panel 18 may alternatively be formed from one panel member.

### REFERENCE SIGNS LIST

10 suspension member, 12 side rail, 14 front cross member, 16 rear cross member, 18 upper panel, 20 front upper panel, 22 rear upper panel, 24 lower panel, 26 rail reinforcement, 28 upper wall, 30 side wall, 32 base surface, 34 bead, 36 fastening seat surface, 38 fastening hole, 40 step portion, 42 notch, 44 drainage hole.

1. A suspension member comprising:
a pair of side rails that extend in a front-and-rear direction;
a pair of cross members that connect the pair of side rails; and
a rail reinforcement that is attached to the side rail and that has an upper wall and a side wall, wherein
the rail reinforcement comprises:
a step portion in which a height of an upper surface of the upper wall changes by a certain degree or greater in the front-and-rear direction; and
a notch formed on the side wall, and formed at a position in the front-and-rear direction approximately coinciding with the step portion.

2. The suspension member according to claim 1, wherein
the step portion is a groove-shaped portion depressed in comparison with regions in front of and in rear of the step portion.

3. The suspension member according to claim 1, wherein
the upper wall comprises a base surface and a bead bulging upward relative to the base surface, and
a width of the bead at the step portion is smaller than widths of the bead at regions in front of and in rear of the step portion.

4. The suspension member according to claim 1, wherein
the upper wall comprises a base surface and a bead bulging upward relative to the base surface, and
the notch reaches from a lower end of the side wall to the base surface.

5. The suspension member according to claim 4, wherein
the side rail is formed by joining an upper panel, and a lower panel disposed at a lower side of the upper panel,
the upper panel comprises a front upper panel, and a rear upper panel which extends from a region near a rear end of the front upper panel toward a rear side of a vehicle,
the rail reinforcement is disposed at a lower side of the front upper panel,
a rear end portion of the front upper panel, a rear end portion of the rail reinforcement, and a front end portion of the rear upper panel overlap each other in an up-and-down direction, and
the base surface has a lowest height, and a gap is present between the base surface and the front upper panel, at a position in the front-and-rear direction coincident with the step portion.
